(19) United States
(12) Patent Application Publication
(10) Pub. No.: US 2004/0098615 A1
(43) Pub. Date: May 20, 2004

(54) Mapping from a single sign-in service to a directory service

(76) Inventors: David R. Mowers, Issaquah, WA (US); John E. Brezak, Woodinville, WA (US); Richard B. Ward, Redmond, WA (US); Scott A. Field, Redmond, WA (US); Todd F. Stecher, Seattle, WA (US); Paul J. Leach, Seattle, WA (US); Donald E. Schmidt, Redmond, WA (US)

Correspondence Address: LEE & HAYES PLLC, 421 W RIVERSIDE AVENUE SUITE 500, SPOKANE, WA, 99201

(21) Appl. No.: 10/298,139

(22) Filed: Nov. 16, 2002

(51) Int. Cl. H04L 9/00

(52) U.S. Cl. 713/201

(57) ABSTRACT

Systems and related methods enable a web service to map a unique identifier received from a client to the client's user account in a directory service using an authentication protocol and thereby receive permission to access resources for the client in the service's domain or in a distant domain. When the unique identifier is a web service unique identifier (PUID), the PUID is changed to a user principal name (UPN) mappable to the client's user account object in the directory service.

### TECHNICAL FIELD

The present invention relates generally to computer access control, and more particularly to methods and systems for mapping from a single sign-in service to a directory service.

### BACKGROUND

Internet services strive to provide secure client access to quality resources. Granting a client permission to access only resources for which the client has proper security clearance has become a primary concern of Internet connectivity. While the need to exclude unwanted clients from privileged resources has heightened as personal information and monetary transactions become commonplace on the Internet, the need to allow authenticated clients that have gained the confidence of the service to enjoy as many resources as possible without having to re-authenticate for each resource has become equally important.

Conventionally, computer systems use centralized databases of client accounts to manage the clients and their access privileges. Highly distributed systems, however, having millions of clients make this centralized control more difficult to implement. Administrating millions of client accounts in databases located across the Internet, and authenticating clients by looking up their personal information in the databases is unwieldy and sometimes impossible.

One solution effectively implemented on computer operating systems is dividing and organizing resources into realms and domains. A MICROSOFT® WINDOWS® domain, for example, is a logical grouping of networked objects (computers, users, files, printers, etc.) that it is not dependent on the physical location of these objects or their place on the network (Microsoft Corp., Redmond, Wash.). WINDOWS® domains provide networking in which security is easier to implement within a limited collection of resources and in which the user is free to enjoy resources within fairly well-defined domain boundaries without having to log-in afresh for each resource.

With the advent of MICROSOFT® WINDOWS®2000 and its ACTIVE DIRECTORY® directory service, collections of domains (“trees”) and collections of trees (“forests”) are stable and have hierarchical features that facilitate scalable organization of clients and resources (Microsoft Corp., Redmond, Wash.). With an ACTIVE DIRECTORY® directory service, account management on a large scale can remain centralized, domain accounts can allow or refuse access to domain resources, and discrete aspects of control can be delegated.

A client can use a unique identifier potentially recognizable in any domain to facilitate enjoyment of resources spread widely over the domains, trees, and forests of the Internet. A unique identifier, such as the PASSPORT® unique identifier, or “PUID” of the MICROSOFT® .NET™ PASSPORT® web service and single sign-in (SSI) authentication service, allows a user to gain access to a large number of resources through a MICROSOFT® .NET™ web service framework (Microsoft Corp., Redmond, Wash.). A PUID remains unique to a client because the network-side identifier that forms the basis of the PUID is assigned at the time of registration of a new sign-in name and although sign-in names may potentially be recycled or even reassigned by domain authorities, the network-side unique identifier (and thus the resulting PUID) are never reused.

A PUID can be verified by examining a PUID cookie without having to refer to a .NET™ PASSPORT® centralized service. Existing operating systems and their administrative tools, however, can process only client accounts but not PUIDs. Thus, a way is needed for operating systems being employed in a large system, such as a .NET™ PASSPORT® web framework, to continue using client accounts while the .NET™ PASSPORT® clients themselves and the web framework use PUIDs.

### SUMMARY

Systems and related methods are described that enable a web service to map a unique identifier received from a client to the client's user account in a directory service using an authentication protocol, such as Kerberos. The unique identifier, which can be converted to a mapping text string, directly addresses the client's user account enabling a security context for the web service to access resources for the client in the web service's domain or in a distant domain.

The unique identifier can be a persistent piece of information, such as a password, that can be used by the client for logon, identification, and/or authentication at other times and with other services. When the unique identifier is a .NET™ PASSPORT® web service unique identifier (PUID), the PUID value is changed to part of a user principal name (UPN) text string that is mappable to the user's account object in an ACTIVE DIRECTORY® directory service.

Related exemplary subject matter allows the service to identify the domain of a client that is outside the service's domain, and to access resources for the client outside the service's domain. Other related subject matter allows the service to include tracking and security identifier (SID) filtering when mapping the unique identifier to a user account to access resources on behalf of the client.

### BRIEF DESCRIPTION OF THE DRAWINGS

FIG. 1 is a block diagram of an exemplary client-server computer network environment suitable for practicing exemplary systems and methods.

FIG. 2 is a block diagram of an exemplary identity mapping system for mapping a client's unique identifier to a client account.

FIG. 3 is a flow diagram of an exemplary method of mapping a client's unique identifier to a client account.

FIG. 4 is a diagram of exemplary PUID and UPN data structures.

FIG. 5 is a flow diagram of an exemplary method of finding a client's domain.

FIG. 6 is a flow diagram of an exemplary method of accessing resources in a distant domain on behalf of a client.

FIG. 7 is a block diagram of an exemplary computing device suitable for implementing exemplary subject matter.

### DETAILED DESCRIPTION

Overview

In the following discussion, exemplary methods and systems are described for enabling a web server (“service”) to obtain permission to access resources on behalf of a client in the service's domain or in a distant domain. The service receives a unique identifier from the client that can be used by the client for logon, identification, and/or authentication at other times and with other services. After authenticating the client, the service uses the unique identifier to map to the client's user account using an authentication protocol, that is, to directly address the client's user account without having to perform a back-end database search for client account information. The service then obtains permission to access resources for the client as allowed by attributes in the client's user account.

Suppose Alice is a client who wants to read her email, check her bank account, and order an airplane ticket online. Conventionally, Alice would have to perform three separate logons to the email service, the bank, and the travel agency. She might use the same username and password to log onto and access all three resources, but more likely she would use different passwords so that if the email password became compromised the bank account password and the travel agency password would remain secret. This, however, requires remembering and presenting multiple passwords during three separate logons.

With the exemplary methods and systems described herein, Alice can use one password or other unique identifier to log onto one service. Once Alice gains the confidence (trust) of the service through an authentication, the service maps Alice's unique identifier using an authentication protocol to Alice's user account in the directory service of the service's domain. After mapping the unique identifier, the service is authorized to access all services in the domain for Alice, such as the email, bank account, and travel agency, if those services are allowed by the user identities and group memberships in Alice's user account. Alice can wield one unique identifier to access a score of resources and the unique identifier can be permanent, i.e., not just limited to one online session.

In an exemplary method, the unique identifier is a piece of data (e.g., the client's .NET™ PASSPORT® web service PUID), which is used to invoke an authentication protocol, such as Kerberos. The unique identifier is sent to the directory service using the authentication protocol, and specifically, using an authentication protocol extension that allows the service to request a service ticket for itself (not for the client) to access resources for the client. In other words, once the service trusts the client, the service itself accesses resources for the client. In the directory service, the unique identifier is mapped to the client's user account, for example a user account object in an ACTIVE DIRECTORY® directory service, in order to find out which resources the service is eligible to access for the client.

Using related exemplary methods, the service can discover the domain name of a distant client in an unknown domain and then access resources for the client across domain boundaries along a trusted path from client to service.

The exemplary subject matter provides WINDOWS® operating systems having an ACTIVE DIRECTORY® directory service with native support for mapping .NET™ PASSPORT® web service PUIDs to WINDOWS® accounts. This integrates .NET™ PASSPORT® web service authentication with authentication and authorization models used in WINDOWS® 2000 platforms and .NET™ PASSPORT® web service frameworks.

Exemplary Computing Environment

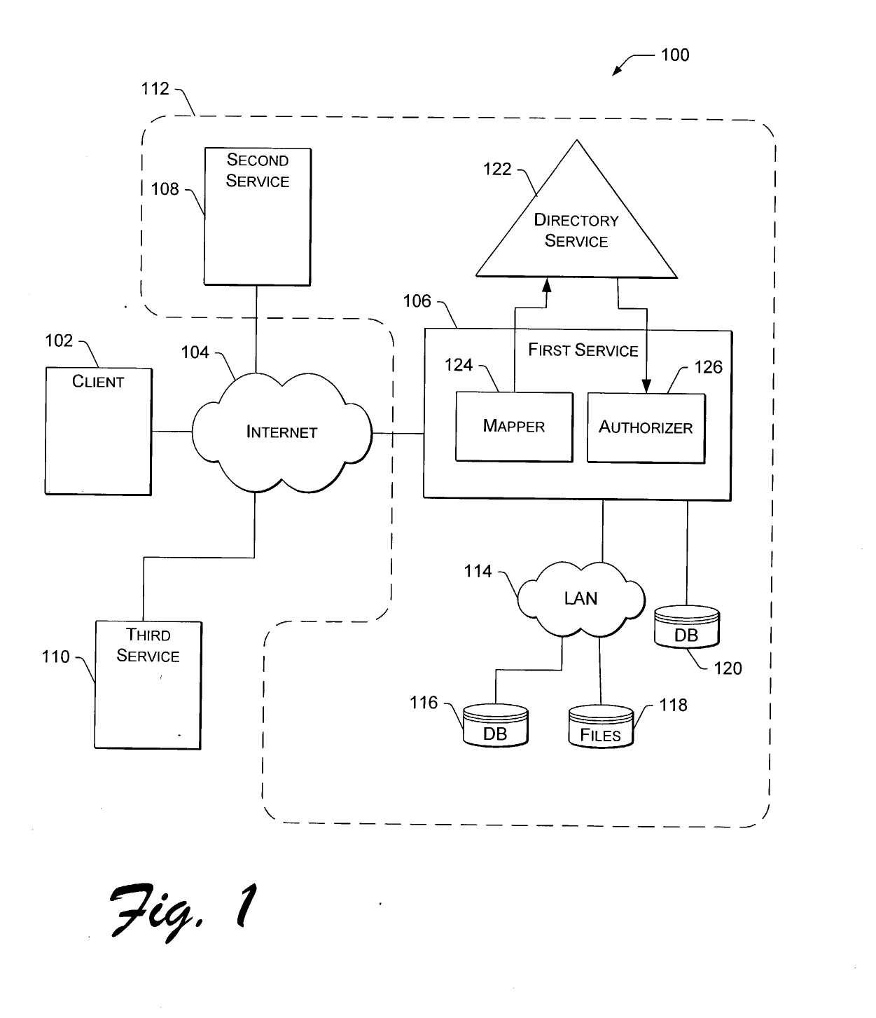

FIG. 1 shows an exemplary computer client-server environment 100 for practicing implementations of the described subject matter. The client-server environment 100 includes a client 102 connected with an internet 104. The internet 104 may be a local internet or the public Internet, or another type of data communications network. A first web server computing device (“first service”) 106, is also communicatively coupled with the internet 104. The first service 106 may be a standalone server for a website or may be front-end server for a website that logs in and authenticates clients before referring the clients to back-end data services. A second service 108 and a third service 110 are also connected to the internet 104. The second service 108 is within the domain 112 of the first service 106, but the third service 110 is outside the domain boundary of the first service 106.

Resources in the domain 112 that are potentially available for access by the service 106 on behalf of the client 102 include stored data available over a local area network (LAN) 114, such as a first database 116 and stored files 118, as well as a second database 120 connected with the first service 106 but not connected via the LAN 114. The second service 108 is also a resource within the domain 112. All the resources in the domain 112 may be geographically separated, hence the domain 112 is a logical not a physical grouping of components. For example, the first service 106 could be a login server for a large email system, while the second service 108 could be a travel agency server located in another city. All the components and resources of the domain 112 are tracked in the directory service 122, which serves as the central hub for administering the domain 112.

To access resources throughout the domain 112, a client 102, such as Alice, identifies herself to the first service 106 and gains the trust of the first service 106 through an authentication. To become authenticated with the first service 106, Alice may present a unique identifier that is pre-authenticated or pre-certified by an external authentication authority that the first service 106 trusts. If the client 102, Alice, does not present a trustworthy unique identifier, then the first service 106 can redirect her and request that she retrieve evidence of authenticity from an external authentication authority.

In one exemplary implementation, the first service 106 includes a mapper 124 and an authorizer 126. The mapper 124 receives a unique identifier from the client 102, and maps the unique identifier to a user account for the client 102 in the directory service 122. The mapper 124 can make use of a unique identifier that persists for the client 102 so that the unique identifier can be used repeatedly at many types of services, or, at services that participate in a common scheme to accept the unique identifier as identification and/or authentication. Since the unique identifier is directly mapped in one form or other to the directory service 122, a back-end database search for personal client information is avoided. In other words, in an exemplary implementation, the user account of the client 102 is directly content addressable using the unique identifier for addressing content.

Once the user account is mapped to, the first service 106 gains permission to access resources as allowed by attributes of the user account. For example, the user account may contain attributes that allow the authorizer 126 to complete requests from the client 102 for access to the first database 116 and the stored files 118, but the same attributes may require the authorizer 126 to refuse to follow a request from the client 102 to access the second database 120 and the second service 108.

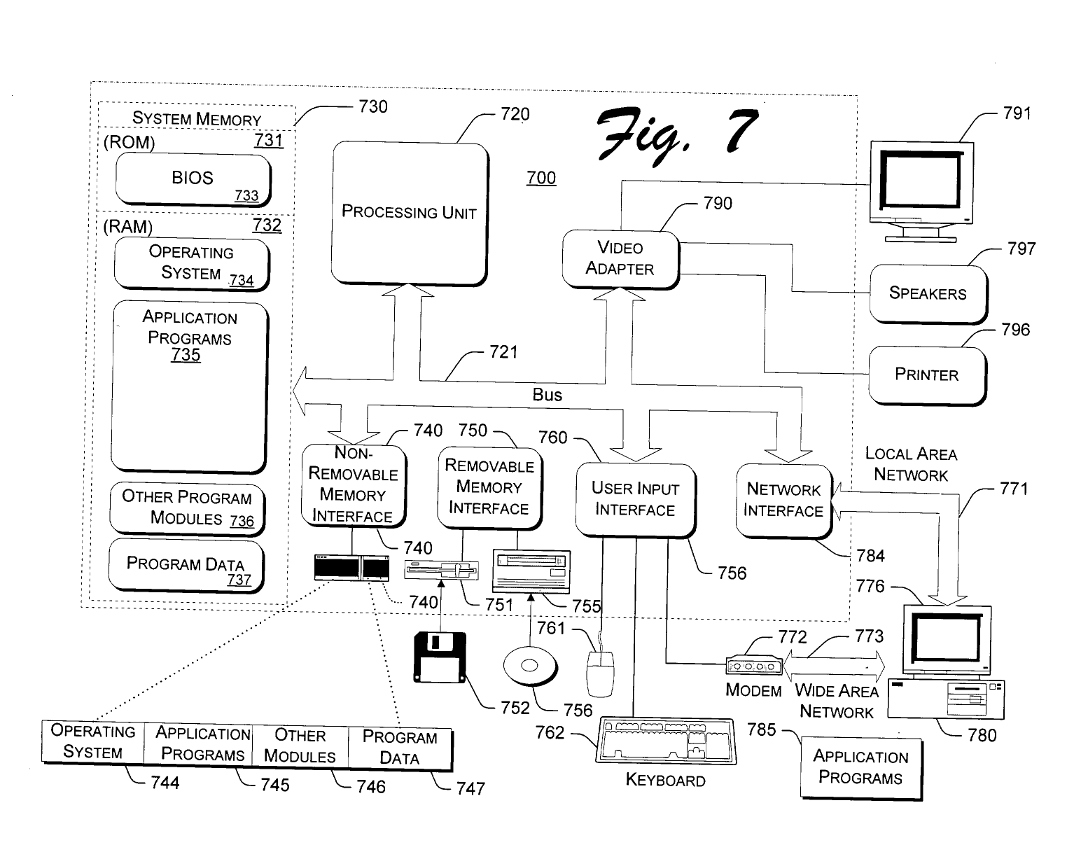

Both the first service 106 and the computing device of the client 102 can be implemented as conventional, general desktop computers or computers of other types, although specialized computers and other more specific-purpose devices might also be used to perform the functions of these components. A specific and detailed example of a computer suitable for performing the described functions will be set forth below, in conjunction with FIG. 7.

In the described client-server environment, the first service 106 may run a version of the MICROSOFT® WINDOWS® server operating system and may include features such as an ACTIVE DIRECTORY® directory service. Application programs in this environment may execute on the first service 106 rather than on the client 102. It should be noted that although the exemplary subject matter is described as being implemented within the MICROSOFT® WINDOWS® server operating system, other implementations are also contemplated. A variety of operating systems and/or other conditions could be used wherein a first service 106 maps a unique identifier of a client 102 to a user account in a directory service 122 in order for the first service 106 to gain permission to access resources for the client 102.

Exemplary Identity Mapping System

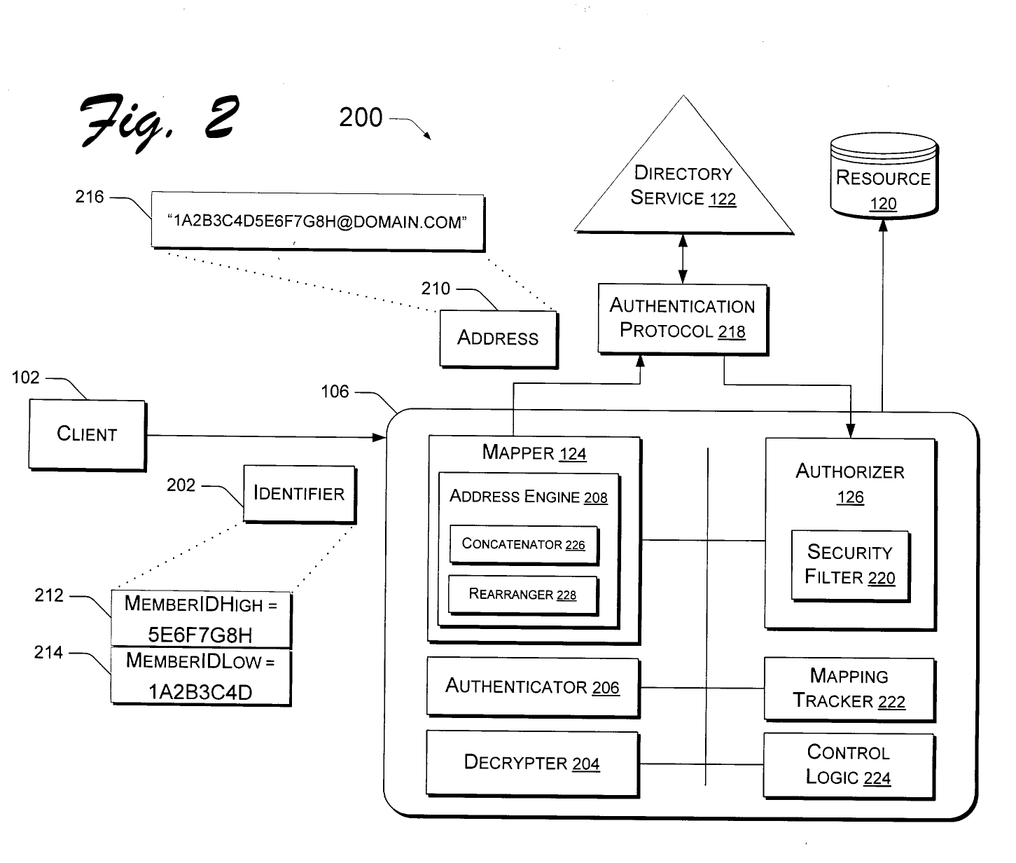

FIG. 2 is a block diagram of an exemplary identity mapping system 200 within a client-server environment. A client 102 sends an identifier 202 to an exemplary service 106, which receives the identifier 202 in a cookie, for example. The exemplary service 106 includes modules, such as the mapper 124 and the authorizer 126 that were shown in FIG. 1. When the identifier 102 is received by the service 106, a decrypter 204 typically performs cryptography, reversing encryption applied to the identifier 202 by the client 102 or by a protocol, such as secure sockets layer (SSL). An authenticator 206 verifies the identifier 202 and establishes a server-validated identification of the client 102. The mapper 124 may include an address engine 208 to manipulate, translate, and/or change the form of the identifier 202 so that the identifier 202 can be used as a mapping address 210. The authorizer 126 may include a security filter 220 to adjust permissions granted to the service 106 based on the client's security identifiers (SIDs) or other account attributes. A mapping tracker 222 to log the mapping of each identifier 202 and/or the accessing of each resource 120 may also be included with the abovementioned modules; all the modules are communicatively coupled with control logic 224 as illustrated. Each module briefly described above will now be described in more detail.

The decrypter 204 is optionally used to decipher an encrypted identifier 202. If the identifier 202 is a PUID, the decrypter 204 can be a decoding and/or a managing object, such as, the .NET™ PASSPORT® web service MSPPMRG.dll object.

After the identifier 202 is optionally processed by the decrypter 204, the authenticator 206 identifies the client 102 and authenticates the identity of the client 102 with respect to the service 106. The authenticator 206 may accept authentication credentials, such as an authentication ticket included in a cookie by a .NET™ PASSPORT® web service central authority (e.g., if the unique identifier is a PUID, then the .NET™ PASSPORT® web service central authority will have authenticated the cookie sent to the service 106. The service 106 can then authenticate the client 102 to the service's satisfaction by reading an authentication ticket provided in the cookie by the .NET™ PASSPORT® web service central authority). However, the authenticator 206 may also deny a client request based on a lack of authentication credentials.

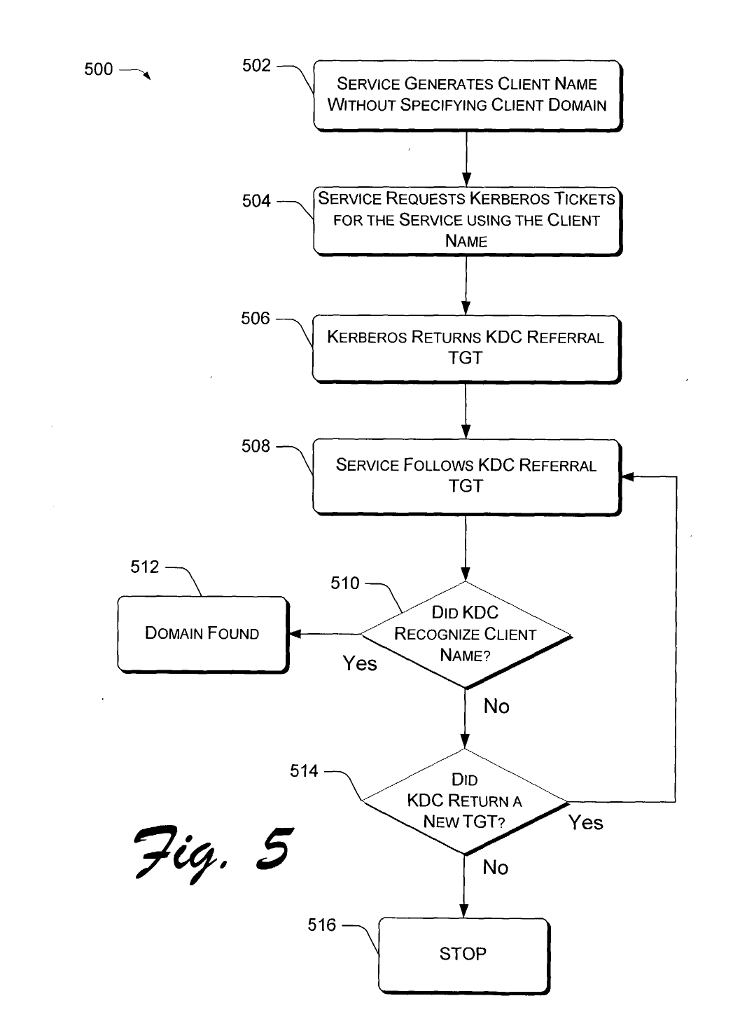

If the authenticator 206 is not able to identify the domain of the client 102, then the service 106 may use an exemplary method of discovering the domain of the client 102. Such an exemplary method is discussed below in relation to FIG. 5.

The mapper 124 uses the identifier 202 as an address 210 for mapping directly to a client user account in the directory service 122. “Direct mapping” as used here, means that the mapper 124 does not have to use the identifier as a key for performing a database search for an address 210 to relate to the identifier 202, and/or use the address 210 as a key for performing a database search for personal client information to relate to the address 210. Rather, the mapper 124 uses the identifier 202 itself as at least part of the address 210. The address engine 208 may change the form of the identifier 202 to arrive at the address 210, but performing a database search, such as a structured query language (SQL) search, in order to relate the identifier 202 to an address stored in a back-end database record is not needed nor employed.

If the identifier 202 is a PUID, the address engine 208 of the mapper 124 converts, translates and/or modifies the form of the PUID to create the “userID” portion of a user principal name (UPN) text string 216 that is used as the address 210. PUIDs are generally 64-bits long and composed of a combination of two 32-bit profile attributes, MemberIDHigh 212 and MemberIDLow 214. PUIDs are presently comprised of this combination due to lack of general support for 64-bit internal data types. The address engine 208 may use a string function to change the 64-bit PUID value or the two 32-bit PUID attribute values into the “userID” text string portion of the UPN text string 216. A concatenator 226 adds the “userID” text string to a domain name text string, for example, by concatenating strings of hex character representations of the two 32-bit values, appending an “@” character, and adding the domain name (including extension) of the domain 112 having the directory service 122 with the client's user account. Since the “userID” text string portion of the resulting UPN text string 216 is the PUID in text string form, the “userID” portion remains unique and is always mappable within the domain 112 to the client's user account in a one-to-one manner.

A rearranger 228 in the address engine 208 may optionally rearrange the “userID” text string before the concatenator 226 adds it to the domain name text string to create the UPN text string 216. If used, a rearrangement scheme is applied consistently when setting up the user accounts so that resulting rearranged UPN text strings are mappable to user accounts with matching rearranged addresses. In some implementations, such a scheme of rearranging the symbols in the “userID” text string may simplify the mapping process or facilitate adding the UPN text string 216 to an attribute used with an authentication protocol 218.

In an exemplary implementation, the mapper 124 passes the address 210 to the directory service 122 using an authentication protocol 218, such as Kerberos. The directory service 122 may be an ACTIVE DIRECTORY® directory service, in which case the client's user account is a user account object. If the authentication protocol 218 is Kerberos, then the PUID identifier 202, translated to an address 210 of UPN text string 216 form, can be added to a Kerberos attribute value, such as altSecurityldentity. The Kerberos authentication protocol 218 can look up the client's user account object in the directory service 122 explicitly and implicitly by UPN as well as via the altSecurityldentity attribute. The latter may utilize a Kerberos extension, such as a service-for-user (S4U) extension. The contents of the client user account object identified by the UPN text string 216 allow the Kerberos authentication protocol 218 to obtain a ticket or tickets to build a security context for the authorizer 126 to allow the service 106 to access resources 120 on behalf of the client 102.

Earlier, when the authenticator 206 validated the identity of the client 102, (before the mapper 124 sent the address 210 to the directory service 122), a service-validated identity was established for the client 102. After the address 210 is mapped to the client's user account, a domain-validated identity is established on behalf of the client 102 enabling the authorizer 126 to set up a security context or token for the service 106 to execute the original resource request from the client 102. If the client's original target resource 120, for example, is a subscription website in the domain 112, the uniform resource locator (URL) for the website will now be executed by the authorizer 126.

When the client's user account is an object in an ACTIVE DIRECTORY® directory service 122, a domain-wide validated ID for the client 102 exists as a token or security context in the authorizer 126, and requests for access to additional resources do not require a corresponding re-authentication of the client 102 for each resource 120.

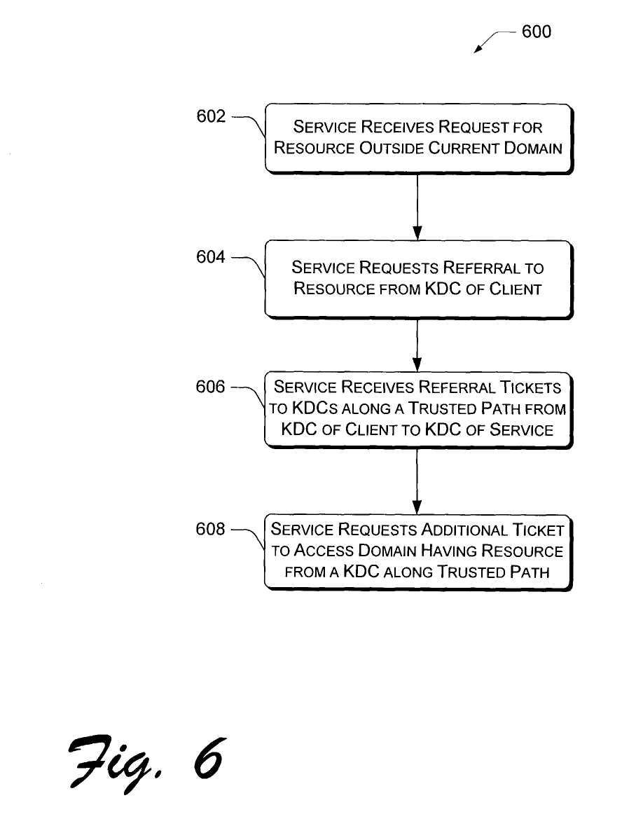

Besides being able to access resources 120 within the current domain 112 without re-authenticating for each one, a domain-validated client 102, via the service 106, can be referred to resources outside the current domain 112, i.e., in another domain or forest, without re-authenticating for each resource 120. In other words, in one exemplary implementation, once the UPN text string 216 form of the identifier 202 has been mapped to the client's user account object in the ACTIVE DIRECTORY® directory service 122, the client 102 can be located and referred like any other native user in the domain 112. An exemplary method of accessing resources across domain boundaries for the client 102 will be discussed below in FIG. 6.

A security filter 220 is optionally coupled with the authorizer 126. The client's user account in the directory service 122 may contain security identifiers (SIDs) that may limit or modify permissions granted to the authorizer 126 to access resources for the client 102. In some authentication protocol extensions, such as the Kerberos service-for-user-to-proxy extension (S4U2proxy), delegation information in the client's user account may be screened by the security filter 220 to allow the authorizer 126 to get tickets for a proxy service to access some resources but not others. Thus, the delegation information may cause the security filter 220 to limit the authorizer 126 from delegating resource requests to other services.

A mapping tracker 222 may be included in the exemplary service 106 to keep track of identifiers mapped, permission(s) received, and resources accessed. Such tracking may be desirable for troubleshooting problems, keeping statistics, and/or for tracking application-level events, such as financial transactions, chain of custody trails, etc.

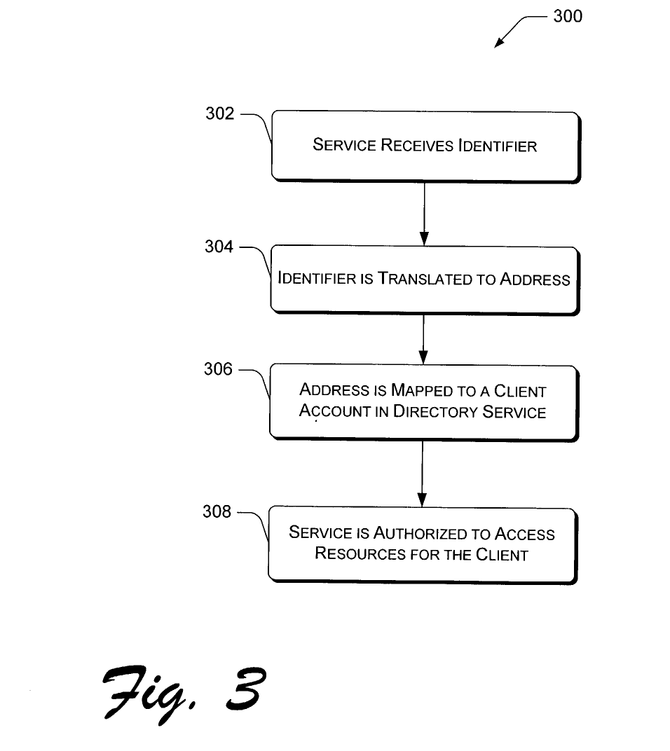

FIG. 3 shows an exemplary method 300 of using a client's unique identifier 202 to map to the client's user account in order to determine access privileges of a service accessing resources on the client's behalf. According to this method 300, the service 106 is programmed to receive an identifier 202 from a client 102 and map the identifier 202 to a client's user account in a directory service 122.

This method 300 is described as being executed by the exemplary identity mapping system shown in FIGS. 1 and 2, and the description refers to the modules in those figures accordingly.

In the flow diagram, the operations are summarized in individual blocks. The operations may be performed in hardware and/or as machine-readable instructions (software or firmware) that can be executed by a processor.

In block 302, the service 106 receives a unique identifier 202 from the client 102. For example, the client 102 may be logging onto an email account that asks for the client's email address and a password. The email address and password may be verified by an external trusted authority, which sends a communication containing a unique identifier 202 for the client 102 to the service 106. However, this is just one example of an identifier 202 being received by the service 106. Reception of the unique identifier 202 may occur via a cookie, or may involve a more complex dialogue between client 102 and service 106 in which the service 106 refers the client 102 back-and-forth several times to an external authentication service to obtain enough evidence of authenticity to satisfy the service 106.

At block 304, the unique identifier 202 is changed in form to an address 210 that can be mapped to the client's user account in the directory service 122. In an exemplary method, if the unique identifier is a 64-bit PUID value, an address engine 208 can change the PUID value into at least a portion of a UPN text string 216 of the form “userlD@domain.com.” There are many other ways the address engine 208 could modify an identifier 202 into an address 210, depending on the nature of the identifier 202, for example by hashing and/or bit-masking the identifier 202. In one exemplary implementation, the identifier 202 is the address 210 with no translation, conversion, and/or other changes required. In this case, the identifier 202 is authenticated and passed in an unaltered form using the authentication protocol 218 to the directory service 122 for mapping.

At block 306, the mapper 124 sends the address 210 to the directory service 122 for mapping to the client's user account. In an exemplary method, a PUID in UPN text string 216 form is sent using a Kerberos authentication protocol 218 to an ACTIVE DIRECTORY® directory service 122 in the domain 112 for mapping to the client's user account.

At block 308, the service 106 is granted permission to access resources 120 for the client 102, based on group memberships and resource privileges in the client's user account in the directory service 122. Using the exemplary method 300 described above, the service 106 does not need to impersonate the client 102 by presenting a client ticket-granting-ticket (TGT) to the authentication authority of each desired target resource 120, rather, the service 106 obtains authorization to access resources 120 itself, or at least to present its own TGTs to authentication authorities of resources 120 requested by the client 102.

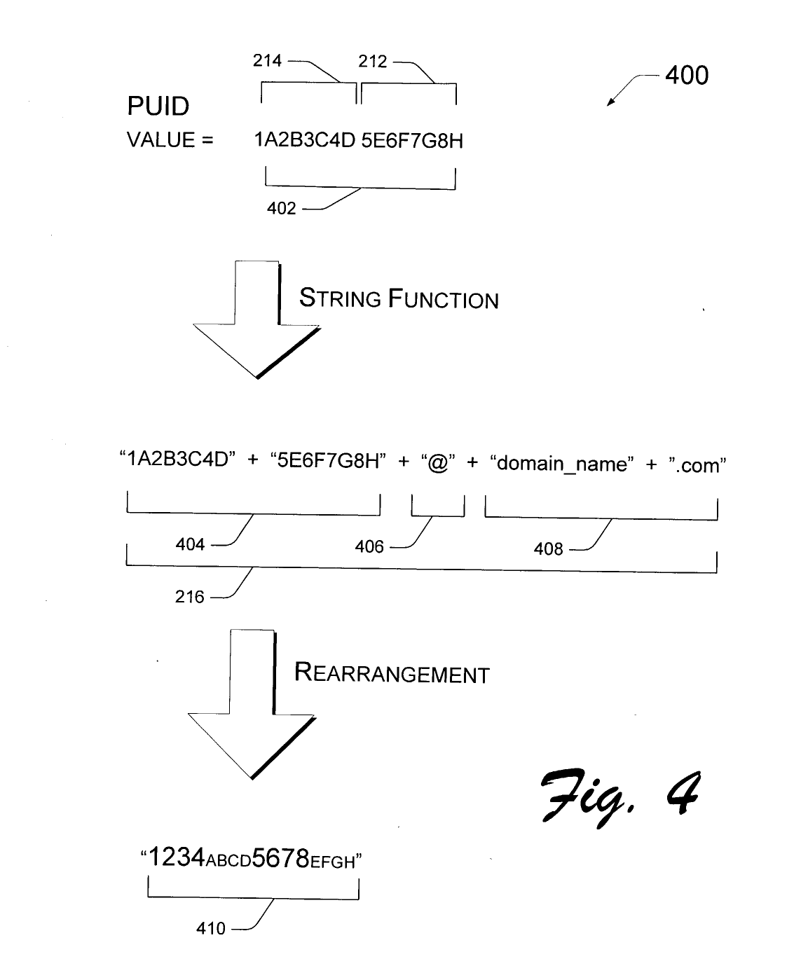

FIG. 4 shows exemplary data structures 400 during conversion of a .NET™ PASSPORT® web service PUID received from a client 102 into a UPN text string 216. To effect these data structures 400, the address engine 208 is programmed to receive an identifier 202 from a client 102 and change the identifier 202 into UPN text string 216 form.

The conversion between data structures 400 is described as being executed by one or more modules of the exemplary identity mapping system shown in FIGS. 1 and 2, and the description refers to the modules in those figures accordingly.

The conversion operations may be performed in hardware and/or as machine-readable instructions (software or firmware) that can be executed by a processor.

A 64-bit PUID 402 consists of two 32-bit values, the memberIDhigh attribute 212 and the memberIDlow attribute 214. Using a string function, the PUID is changed from a value or values (e.g., numeric values or byte values) to a text string, such as the “userID” text string portion 404 of a UPN text string 216. A concatenator 226 adds the “userID” text string portion 404 to an “@” symbol 406 and a domain name text string 408, including a “.com” or other extension, that corresponds to the domain 112 in which an ACTIVE DIRECTORY® directory service 122 holds a user account object for the client 102.

In an optional variation, a rearranger 228 changes the order of the symbols in the “userID” text string portion 404 to a rearranged text string 410 to facilitate mapping and/or addition to an attribute of the authentication protocol 218.

Once the UPN text string 216 is formed by the address engine 208, the UPN text string 216 can be passed using the authentication protocol 218 to the directory service 122 to be mapped to the client's user account.

FIG. 5 shows an exemplary method 500 of discovering the domain of a client 102 using an authentication protocol 218, such as Kerberos. This method 500 is described as being executed by the exemplary identity mapping system shown in FIGS. 1 and 2, and the following description refers to the modules in those figures accordingly.

In the flow diagram, the operations are summarized in individual blocks. The operations may be performed in hardware and/or as machine-readable instructions (software or firmware) that can be executed by a processor.

In block 502, the service 106 generates a client name that does not specify a client domain. In one implementation, a “userID” text string portion of a UPN text string 216 that does not specify a domain name may be used. The “userID” text string may be the unique identifier 202 received from a client 102, i.e., the service 106 may not recognize the client's domain from the received identifier 202.

In block 504, the service 106 requests tickets for itself on behalf of the client 102 using the client name generated in block 502. This ticket request prompts the Kerberos security support provider (SSP) to attempt discovery of the client's domain. For example, this can be accomplished by sending an authentication request for the client 102 to the service's key distribution center (KDC), as if the client 102 were attempting logon.

In block 506, the Kerberos SPP returns one or more referral ticket(s). A referral ticket is a TGT that allows the service 106 to ask another KDC within a trusted path proceeding from the referring KDC to authenticate the client 102 because the referring KDC did not recognize the client 102.

In block 508, the service 106 follows the KDC referral ticket to the KDC of the next trusted domain. If the client name exists in any of the next trusted domains within the trusted path, the service 106 can usually follow Kerberos referrals to reach the client's domain.

In block 510, if a KDC recognizes the client name (even if recognition consists of returning an error message that implies the KDC recognizes the client name), then the client's domain has been located, as shown in block 512. But if the KDC does not recognize the client's name, then the method passed to the next decision block.

In block 514, if a KDC along the referral path does not return a TGT, then the discovery stops, as shown in block 516. If a KDC returns a TGT, however, then the discovery continues by looping back to the process in block 508.

FIG. 6 shows an exemplary method 600 of accessing resources across domain boundaries, using a Kerberos protocol. This method 600 is described as being executed by the exemplary identity mapping system shown in FIGS. 1 and 2, and the following description refers to the modules in those figures accordingly.

In the flow diagram, the operations are summarized in individual blocks. The operations may be performed in hardware and/or as machine-readable instructions (software or firmware) that can be executed by a processor.

At block 602, the service 106 receives a request from a client 102 for resources outside the domain 112 of the service, that is, in a distant domain.

At block 604, the authorizer 126 allows the service 106 to make an initial referral request for the resources to the KDC of the client 102.

At block 606, the authorizer 126 of the service 106 receives referral tickets from the client's KDC to domains along a trusted path from the client's KDC to the service's KDC. Each referral ticket includes a privilege access certificate of the client 102 with the name and Kerberos realm of the service 106. The mapper 124, which in one exemplary implementation can keep track of domain names for purposes of creating UPNs, establishes a map of the domains in the trusted path of domains.

In block 608, the authorizer 126 uses one of the referral tickets to request an additional ticket for the service 106 from the KDC of a distant domain, since each ticket has the name and Kerberos realm of the service 106. The additional ticket is used to access a desired resource in the distant domain, i.e., the distant domain associated with the KDC from which the additional ticket was requested.

Hardware and Software Implementation The exemplary systems and related methods described above enable a service 106 to map a unique identifier 202 received from a client 102 using an authentication protocol 218 to the client's user account in a directory service 122 and thereby receive permission to access resources for the client 102 in the service's domain 112 or in a distant domain.

It should be noted that the subject matter described above can be implemented in hardware, in software, or in both hardware and software. In certain implementations, the exemplary system and related methods may be described in the general context of computer-executable instructions, such as program modules, being executed by a computer. Generally, program modules include routines, programs, objects, components, data structures, etc. that perform particular tasks or implement particular abstract data types. The subject matter can also be practiced in distributed computing environments where tasks are performed by remote processing devices that are linked through a communications network. In a distributed computing environment, program modules may be located in both local and remote computer storage media including memory storage devices.

A specific and detailed example of a computer suitable for implementing the exemplary systems and methods described above will be set forth below in FIG. 7.

Exemplary Computing Device

With reference to FIG. 7, the components of computer 700 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISAA) bus, Video Electronics Standards Association (VESA) local bus, and Peripheral Component Interconnect (PCI) bus also known as the Mezzanine bus.

Computer 700 typically includes a variety of computer-readable media. Computer-readable media can be any available media that can be accessed by computer 700 and includes both volatile and nonvolatile media, removable and non-removable media. By way of example, and not limitation, computer-readable media may comprise computer storage media and communication media. Computer storage media include volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 700. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 700, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 700 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface such as interface 750.

The drives and their associated computer storage media discussed above and illustrated in FIG. 7 provide storage of computer-readable instructions, data structures, program modules, and other data for computer 700. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer 700 through input devices such as a keyboard 762 and pointing device 761, commonly referred to as a mouse, trackball, or touch pad. Other input devices (not shown) may include a microphone, joystick, game pad, satellite dish, scanner, or the like. These and other input devices are often connected to the processing unit 720 through a user input interface 760 that is coupled to the system bus, but may be connected by other interface and bus structures, such as a parallel port, game port, or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 795.

The computer may operate in a networked environment using logical connections to one or more remote computers, such as a remote computer 780. The remote computer 780 may be a personal computer, a server, a router, a network PC, a peer device or other common network node, and typically includes many or all of the elements described above relative to computer 700, although only a memory storage device 781 has been illustrated in FIG. 7. The logical connections depicted in FIG. 7 include a local area network (LAN) 771 and a wide area network (WAN) 773, but may also include other networks. Such networking environments are commonplace in offices, enterprise-wide computer networks, intranets, and the Internet.

When used in a LAN networking environment, the computer 700 is connected to the LAN 771 through a network interface or adapter 770. When used in a WAN networking environment, the computer 700 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 700, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

Conclusion

The foregoing discussion describes exemplary methods of securely authorizing a service to access resources for a client using a unique identifier from the client. Although the invention has been described in language specific to structural features and/or methodological acts, it is to be understood that the subject matter defined in the appended claims is not necessarily limited to the specific features or acts described. Rather, the specific features and acts are disclosed as exemplary forms of implementing the claimed invention.

1. A method of authorizing a computing service to access resources for a client, comprising:
receiving a unique identifier from the client;
mapping the unique identifier as an address to a client account; and
authorizing the computing service to access the resources for the client based on the client account.

2. The method as recited in claim 1, further comprising:
identifying a domain of the client and a domain of the computing service;
establishing a path of domains between the domain of the client and the domain of the service; and
accessing the resources from a domain in the path of domains.

3. The method as recited in claim 1, wherein the unique identifier is a web service unique identifier (PUID) and the address is a user principal name (UPN):

4. The method as recited in claim 3, wherein the UPN is a text string derived from a PUID value.

5. The method as recited in claim 1, wherein the client account is a user account object stored in a directory service.

6. The method as recited in claim 1, wherein the mapping proceeds using an authentication protocol.

7. The method as recited in claim 6, wherein the address is added to an altSecurityIdentity attribute of a Kerberos authentication process to access the client account.

8. The method as recited in claim 7, wherein the Kerberos process grants the service a security context for authorizing the service to access resources for the client.

9. The method as recited in claim 1, further comprising filtering a security identifier in the client account to limit authorizing the computing service to access the resources.

10. The method as recited in claim 1, further comprising tracking the resources accessed by the computing service for the client.

11. A server system for allowing server access to domain resources on behalf of a client, comprising:
an authenticator to receive a unique identifier from the client and to verify an identity of the client based on the unique identifier, wherein the unique identifier is reusable by the client for one or more of logging, identifying, and authenticating the client at various services other than the server system;
a mapper to use the unique identifier as an address to access a client account using an authentication protocol; and
an authorizer to allow the server to access the domain resources based on the client account.

12. The server system as recited in claim I1, wherein the authorizer allows the server to access domain resources from multiple domains and forests of domains.

13. The server system as recited in claim 11, wherein the authorizer builds a security context for the server to execute a request made by the client for a resource.

14. The server system as recited in claim 11, further comprising an address engine to change a web service unique identifier (PUID) into a user principal name (UPN) address.

15. The server system as recited in claim 14, wherein the UPN is a text string derived from a PUID value.

16. The server system as recited in claim 11, wherein the authentication protocol is a Kerberos process.

17. The server system as recited in claim 16, wherein the address is added to an altSecurityIdentity attribute of the Kerberos process to access the client account.

18. The server system as recited in claim 11, further comprising a decrypter to decipher an encoded unique identifier.

19. The server system as recited in claim 11, further comprising a security filter to limit the server from accessing the resource based on a security identifier in the client account.

20. The server system as recited in claim 11, further comprising a mapping tracker to keep a record of access privileges granted to the server and resources accessed by the server for the client.

21. One or more computer readable media containing instructions that are executable by a computer to perform actions comprising:
mapping a unique identifier from a client computing device to a client account object in a directory service; and
based on the client account object, authorizing a server computing device to complete a request from the client computing device for a resource.

22. One or more computer readable media as recited in claim 21, the actions further comprising completing a request for a resource from a different computing domain than the computing domain of the server.

23. One or more computer readable media as recited in claim 21, wherein the mapping includes translating a web service unique identifier (PUID) from a value to at least part of an address string.

24. One or more computer readable media as recited in claim 23, wherein the address string is a user principal name (UPN).

25. One or more computer readable media as recited in claim 21, further comprising mapping using a Kerberos authentication protocol.

26. One or more computer readable media as recited in claim 21, wherein the actions further comprise:
authenticating an identity of the client to establish a server-validated client identification;
mapping the server-validated client identification to the client account object to establish a domain-validated client identification, wherein the domain validated client identification allows the service to access domain resources for the client.

27. One or more computer readable media as recited in claim 21, the actions further comprising filtering security attributes in the client account object to determine a permission to grant to the service.

28. One or more computer readable media as recited in claim 27, the actions further comprising tracking permissions granted to the service.

29. A data structure for a user principal name (UPN) for mapping a client identity to a user account object in a directory service, comprising:
a domain name text string corresponding to the directory service; and
a user identity text string corresponding to the client identity, wherein the user identity text string is added to the domain name text string.

30. The data structure as recited in claim 29, wherein the user identity text string is a text string form of a web service unique identifier (PUID) value.

31. The data structure as recited in claim 30, further comprising rearranging symbols in the user identity text string before adding the user identity text string to the domain text string.

32. A mapper for using a web service unique identifier (PUID) of a client as a user principal name (UPN) address to access a client account, comprising:
a means for changing a PUID value into a PUID text string;
a means for adding the PUID text string to a domain name text string to create the UPN, wherein the domain name corresponds to a directory service that includes a user account for the client.

33. The mapper as recited in claim 32, further comprising a means for rearranging symbols in the PUID text string.

34. A method for converting a web service unique identifier (PUID) of a client into a user principal name (UPN), comprising:
changing a PUID value to a PUID text string;
adding the PUID text string to a domain name text string, wherein the domain name corresponds to a domain having a directory service that includes a user account for the client.

35. The method as recited in claim 34, further comprising rearranging an order of symbols in the PUID text string before adding the PUID text string to the domain name text string.

36. The method as recited in claim 34, further comprising a decoding an encoded PUID before changing the PUID value into a PUID text string.

37. One or more computer readable media containing instructions that are executable by a computer to perform actions comprising:
changing a value of a unique client number to a text string;
adding the text string to a domain name text string, wherein the domain name corresponds to a computing domain having a directory service that includes a user account for the client.

38. One or more computer readable media as recited in claim 37, the actions further comprising rearranging an order of symbols in the text string before adding the text string to the domain name text string.

39. A module for locating resources across domain boundaries, comprising:
an authorizer to set a trial security context for sending an initial request for the resources from a server to a Kerberos key distribution center (KDC) of the client and receive back referral tickets from the KDC of the client; and
a mapper to establish from the referral tickets a record of domains in a trusted path of domains from the domain of the client to the domain of the server.

40. The module as recited in claim 39, wherein the authorizer executes a resource location process to access a resource for the client from a domain along the trusted path.

41. A method of accessing resources in a domain separate from the domain of a server, comprising:
sending an initial request from the server to a Kerberos key distribution center (KDC) of the client; and
receiving from the KDC of the client service referral tickets to KDCs along a trusted path from the KDC of the client to the KDC of the server.

42. The method as recited in claim 41, wherein each referral ticket includes a privilege access certificate of the client, a name of the server, and a Kerberos realm of the server.

43. The method as recited in claim 42, further comprising using a referral ticket to request an additional ticket from a KDC along the trusted path for the server to access a resource from a domain along the trusted path.

44. One or more computer readable media containing instructions that are executable by a computer to perform actions comprising:
accessing a Kerberos key distribution center (KDC) of a client; and
receiving from the KDC of the client referral tickets to a trusted path of KDCs.

45. One or more computer readable media as recited in claim 44, the actions further comprising using a referral ticket to request an additional ticket from a KDC along the trusted path for the server to access a resource for the client.

46. A web service authentication system for a computer internet having clients and services, comprising:
a unique identifier for each client;
a first set of the services wherein each service in the first set allows the client to access the service if the client presents the unique identifier; and
a second set of the services wherein if the client presents the unique identifier then a service in the second set:
authenticates the identity of the client,
changes the unique identifier into an account address of the client,
sends the account address to a directory service using an authentication protocol, and
obtains a permission to access resources based on a client account in the directory service.

47. A single sign-in system for allowing a client to access resources on a computer network through services, comprising:
a unique identifier associated with a client, wherein the unique identifier is used, depending on a particular service, for one of identifying the client, authenticating an identity of the client, and mapping to an account of the client to determine authorization for the service to access the resources for the client; and
a mapper in the service to send the unique identifier to a client account to determine privileges for the service to access resources for the client.

48. A method of allowing a computer service to access resources in a computer service domain for a client, comprising:
receiving a permanent unique identifier of the client from the client, wherein the permanent unique identifier is reusable by the client to identify and/or authenticate the client at multiple computer services;
transforming the permanent unique identifier into an address of a client account;
accessing the client account using the address;
granting the service permission based on the client account to access resources in the computer service domain on behalf of the client.

49. The method as recited in claim 48, further comprising authenticating the identity of the client.

50. The method as recited in claim 49, wherein the client account is an object in a directory service.

51. The method as recited in claim 50, wherein the address is a user principal name (UPN).

52. The method as recited in claim 51, wherein the authentication protocol is a Kerberos process.

53. The method as recited in claim 52, wherein the UPN is attached to a Kerberos attribute to map to the object in the directory service.

54. The method as recited in claim 48, further comprising filtering a security identifier in the client account to grant a permission to the service.

55. The method as recited in claim 48, further comprising tracking permissions granted to a service and resources accessed by the service for the client.

56. A method for a computing service to discover a domain of a computing client, comprising:
generating a client name that does not specify the domain of the client;
requesting tickets for the service on behalf of the client using the client name;
sending an authentication request for the client to a Kerberos key distribution center (KDC) of the service to emulate a client logon attempt; and
following Kerberos Security Support Provider (SSP) referrals until the domain of the client is reached.

57. The method as recited in claim 56, wherein if a KDC along a path of referrals does not return a ticket-granting-ticket (TGT), then discontinuing the discovery of the domain of the client.

58. The method as recited in claim 56, further comprising ending the discovery if the Kerberos SSP returns an error message implying that a KDC recognizes the client name.
